(19) United States
(12) Patent Application Publication
(10) Pub. No.: US 2004/0121924 A1
(43) Pub. Date: Jun. 24, 2004

(54) Contact lens care compositions containing chitosan derivatives

(76) Inventors: Bor-Shyue Hong, Arlington, TX (US); David L. Meadows, Colleyville, TX (US); Howard Allen Ketelson, Fort Worth, TX (US); Geoffrey Robert Owen, Southlake, TX (US)

Correspondence Address: ALCON RESEARCH, LTD., R&D COUNSEL, Q-148, 6201 SOUTH FREEWAY, FORT WORTH, TX, 76134-2099, US

(21) Appl. No.: 10/732,755

(22) Filed: Dec. 10, 2003

Related U.S. Application Data
(60) Provisional application No. 60/436,164, filed on Dec. 23, 2002.

(51) Int. Cl. C11D 1/00

(52) U.S. Cl. 510/112

(57) ABSTRACT

The use of compositions containing anionic chitosan derivatives to treat contact lenses is described. The compositions are particularly useful for removing protein deposits from contact lenses, but also serve to lubricate the surfaces of the lenses and enhance the comfort of the lenses when worn on the eyes.

### CLAIM FOR PRIORITY

This application claims priority from U.S.S.N: 60/436,164, filed Dec. 23, 2002.

### BACKGROUND OF THE INVENTION

The present invention is directed to the field of products for treating contact lenses. The invention is particularly directed to enhancement of the cleaning of contact lenses, and to the improvement of the comfort of the lenses when worn on the eye.

Various compositions and methods have been utilized to clean contact lenses prior to the present invention. The prior compositions and methods have included cleaning agents such as surfactants, chelating agents and proteolytic enzymes. The present invention is particularly directed to the removal of protein deposits from contact lenses. The principal component of such deposits is lysozyme.

Lysozyme is one of the major pertinacious components in human tears. It is an enzyme that acts as an antimicrobial agent by degrading glycosidic linkages between N-acetylmuramic acid and N-acetylglucosamine units of the microbial cell wall. Thus, the presence of lysozyme in human tears is a natural defense mechanism against ocular infections. Unfortunately, when contact lenses are placed on the eye, prolonged bathing of the lenses by the tears leads to deposits of lysozyme on the lenses. Lysozyme is a protein, and the deposits on contact lenses are typically composed of a mixture of proteins, lipids and other materials. These deposits become bound to the lenses, and consequently are very difficult to remove.

The use of proteolytic enzymes (e.g., pancreatin) to remove protein deposits from contact lenses has been fairly effective. However, the treatment of contact lenses with cleaning compositions containing proteolytic enzymes is considered by some contact lens wearers to be undesirable, in view of cost, convenience and other factors. Consequently, the use of proteolytic enzyme products to remove protein deposits from contact lenses has declined greatly over the past decade. These products have largely been replaced by complexing agents contained in “multi-purpose” solutions that are used to clean and disinfect contact lenses on a daily is basis. For example, U.S. Pat. No. 5,858,937 (Richard, et al.) describes the use of polymeric phosphonates in multi-purpose solutions to remove protein deposits, and U.S. Pat. No. 5,370,744 (Chowhan, et al.) describes the use of carboxylates (e.g., citrate) for the same purpose. Although multi-purpose solutions containing such complexing agents have been commercially successful, there is a need for improved solutions, particularly solutions that are more effective in preventing and removing protein deposits. The present invention addresses this need.

The present invention is based on a discovery that anionic derivatives of chitosan are effective in removing protein deposits from contact lenses by means of ionic interactions with the lysozyme contained in those deposits. It has also been found that the chitosan derivatives described herein enhance the lubricity of contact lenses and protect corneal epithelial cells from desiccation. All of these functions promote the ocular comfort of persons wearing contact lenses.

The following publications may be referred to for further background regarding chitosan and its derivatives:

Stokke, B. T., Varum, K. M., Holme, H. K., Hjerde, R. J. N., and Smidsrod, O. “Sequence specificities for lysozyme depolymerization of partially N-acetylated chitosans”, Can. J. Chem., 73, 1972-1981 (1995).

Nordtveit, R. J., Varum, K. M., and Smidsrod, O. “Degradation of fully water-soluble, partially N-acetylated chitosans with lysozyme”, Carbohydrate Polymers, 23, 253-260 (1994).

Dung, P., Milas, M., Rnaudo, M., and Desbrieres, J. “Water soluble derivatives obtained by controlled chemical modifications of chitosan”, Carbohydrate Polymers, 24, 209-214 (1994).

Kristiansen, A., Varum, K. M., and Grasdalen, H. “Competitive binding of highly de-N-acetylated chitosans and N,N′-diacetylchitobiose to lysozyme from chicken egg white studied by ¹H NMR spectroscopy”, Carbohydrate Research, 289, 143-150 (1996).

Bernkop-Schnurch, A. and Kast, C. E., “Chemically modified chitosans as enzyme inhibitors”, Adv. Drug Deli. Rev. 52, 127-137 (2001).

Chitin is a naturally occurring biopolymer found in the shells of crustaceans such as shrimp, crab, and lobster, and can be isolated from these shells using aqueous solutions that are highly acidic or highly basic. Since the chitin obtained from such sources is not normally soluble in aqueous solutions at neutral pH, various chemical modifications have been adopted to enhance the solubility of chitin for commercial applications. For example, chitin can be deacetylated to obtain chitosan, which is relatively soluble in aqueous compositions.

Possible industrial uses of chitin, chitosan, and other chitin derivatives have been described in several prior patent publications. Those publications indicate that chitin and its derivatives may be useful as a component of detergents and cosmetics, as well as vehicles for delivering drugs to the eye and other tissues. The formation of contact lenses from chitin or chitin derivatives has also been proposed. The following patent publications may be referred to for further background regarding such prior uses or proposed uses of chitin, chitosan, or derivatives thereof:

U.S. Pat. No. 4,826,826 (Conti);

European Patent Application Publication No. 0 356 060 (Mosbey);

International Publication No. WO 00/60038 (Cantoro);

International Publication No. WO 00/30609 (Gurny, et al.);

International Publication No. WO 94/13774 (Powell, et al.);

U.S. Pat. No. 5,773,021 (Gurtler, et al.);

European Patent Application Publication No. 0 737 602 (Gruber);

U.S. Pat. No. 5,747,475 (Nordquist, et al.);

U.S. Pat. No. 5,015,632 (Nelson);

U.S. Pat. No. 5,422,116 (Yen, et al.);

International Publication No. WO 00/14155 (Ucheegbu);

Japanese Patent Publication No. JP 63193999 (Kao Corp.);

Japanese Patent Publication No. JP 63096111 (Kanebo Ltd.);

Japanese Patent Publication No. JP 59106409 (Ichimaru Pharcos. Inc.); and

Japanese Patent Publication No. JP 56094322 (Mitsubishi Rayon Co., Ltd.).

The use of chitosan derivatives to help preserve solutions from microbial contamination is described in United States Patent Application Publication No. 2002/0177577 A1.

### SUMMARY OF THE INVENTION

The present invention is based on the finding that anionic chitosan derivatives are capable of facilitating the removal of lysozyme deposits from contact lenses via ionic interactions between anionic groups on the chitosan derivatives and cationic sites on the lysozyme.

The chitosan derivatives contained in the compositions of the present invention also exhibit a lubricating effect on the lens surface, thereby enhancing comfort for the contact lens wearer.

The chitosan derivatives also stabilize the tear film and protect corneal epithelial cells from desiccation.

Based on the findings summarized above, the present invention provides contact lens care solutions that effectively remove protein deposits, while also providing lubrication and desiccation protection properties.

The present invention provides compositions and methods for cleaning contact lenses and enhancing the comfort of the lenses when worn on the eyes of patients. The compositions may take various forms, such as multi-purpose solutions for cleaning, disinfecting and storing contact lenses, in-the-eye cleaning products or rewetting drops.

### DETAILED DESCRIPTION OF THE INVENTION

The compositions of the present invention contain one or more anionic chitosan derivatives that are soluble in aqueous solutions at a pH of from 6.5-8.5 and are capable of complexing with lysozyme via ionic interactions.

Chitin is a naturally occurring biopolymer usually isolated from the shells of some crustaceans such as shrimp, crab, and lobster. It is a linear polymer formed through β-(1→4) glycosidic linkage of the monomeric N-acetyl-D-glucosamine. N-deaceylation of chitin leads to formation of chitosan. Chitosan is partially to substantially deacetylated from chitin, and in contrast to chitin contains free amine groups along the polymer chain. Both polymers exist in various molecular weights.

The chitosan derivatives used in the present invention include one or more anionic functional groups, such as sulfuryl chitosan, phosphoryl chitosan, carboxymethyl chitosan, dicarboxymethyl chitosan, and succinyl chitosan. The preferred chitosan derivative is carboxymethyl chitosan. The polymers have molecular weights ranging from 500 to 10,000,000.

The chitosan derivatives that may be utilized in the present invention are either commercially available (e.g., carboxymethyl chitosan is available from KoYo Chemical Co., LTD., Tokyo, Japan); or can be prepared by means of processes that have been described in the scientific literature [e.g., Ryoichi Senju and Satoshi Okimasu, Nippon Nogeikagaku Kaishi, volume 23 pages 432437, (1950); Keisuke Kurita, J Synthetic Organic Chemistry Japan, volume 42 pages 567-574, (1984); and Seiichi Tokura, Norio Nishi, Akihiro Tsutsumi, and Oyin Somorin, Polymer J, volume 15, pages 485-489 (1983)].

The compositions of the present invention contain one or more anionic chitosan derivatives in an amount sufficient to facilitate the removal of protein deposits from contact lenses. This is referred to herein as “an effective amount”. The concentration required for a particular composition will depend on factors apparent to those skilled in the art, such as, the chitosan derivative or derivatives selected for the composition, the molecular weight of the derivative(s) selected, and the viscosity desired for the composition.

The selection of an ideal molecular weight of a particular chitosan derivative and the desired viscosity of the composition can be readily determined by persons skilled in the art. The compositions of the present invention will generally have viscosities in the range of 2 to 3000 cps at 25° C. The preferred viscosity range is from about 5 to 15 cps. The contact lens cleaning compositions of the present invention will generally contain one or more chitosan derivatives in an amount of from about 0.01 to 10 percent by weight/volume (“w/v %”), preferably about 0.1 to 1 w/v %.

The compositions of the present invention may contain various other components in addition to the anionic chitosan derivatives described above, such as surfactants, chelating agents, buffering agents, tonicity adjusting agents, antimicrobial preservatives, and contact lens disinfecting agents.

The surfactants utilized in the compositions of the present invention can be cationic, anionic, nonionic or amphoteric. Preferred surfactants are neutral or noninonic surfactants which may present in amounts up to 5 w/v %. Examples of suitable surfactants include, but are not limited to, polyethylene glycol ethers or esters of fatty acids, polyoxyethylene-polyoxypropylene block copolymers of ethylene diamine (e.g., poloxamines such as Tetronic® 1304 or 1107), polyoxypropylene-polyoxyethylene glycol nonionic block copolymers (e.g., poloxamers, such as Pluronic® F-127), and p-isooctylpolyethylen phenol formaldehyde polymers (e.g., Tyloxapol).

Examples of preferred chelating and/or sequestering agents include ethylenediaminetetraacidic acid (EDTA) and its salts, and citric acid and its salts. Other chelating and/or sequestering agents known to those skilled in the art can also be employed. The sequestering agents are normally employed in amounts of from about 0.025 to 2.0 w/v %.

Examples of suitable cosolvents include glycerin, propylene glycol and polyethylene glycol.

Examples of suitable buffering agents which may be incorporated into the compositions include, but are not limited to, alkaline metal salts, such as potassium or sodium carbonates, acetates, borates, phosphates and citrates, and weak acids, such as acetic acids and boric acids. The preferred buffering agents are alkaline metal borates, such as sodium or potassium borates. Other pH-adjusting agents, such as inorganic acids and bases, may also be utilized. For example, hydrochloric acid, sodium hydroxide, various biological buffers (e.g., HEPES and PIPES), triethanolamine, or BIS-TRIS may be employed in concentrations suitable for ophthalmic compositions. The above-described buffering agents are generally present in amounts from about 0.1 to about 2.5 w/v %, preferably from about 0.5 to about 1.5% w/v %.

Examples to tonicity adjusting agents include ionic agents, such as sodium chloride and potassium chloride, and nonionic agents, such as glycerol, sorbitol and mannitol. The tonicity adjusting agents are utilized to adjust the osmolality of the compositions to more closely resemble that of human tears and to be compatible with contact lens materials. The use of nonionic agents is preferred relative to compositions containing ionic antimicrobial agents (e.g., polyquaternium-1 and PHMB), so as to avoid ionic interactions that may adversely affect the activity of these agents. The compositions of the present invention will generally have an osmolality of about 200 to 400 milliOsmoles per kilogram water (“mOsm/kg”), more preferably about 280 to 320 mOsm/kg.

Suitable antimicrobial agents include, but are not limited to those generally used in multi-purpose contact lens care solutions or in other ophthalmic solutions, such as polyquaternium-1, which is a polymeric quaternary ammonium compound; myristamidopropyl dimethylamine (“MAPDA”), which is a N,N-dialkyl, N′-alkyl, ethylene diamine; polyhexamethylene biguanide (“PHMB”) or polyaminopropyl biguanide (PAPB), which is a polymeric biguanide; and hydrogen peroxide. The antimicrobial agents that may be utilized in the present invention also include the aminobiguanides described in copending U.S. patent application Ser. No. 09/581,952 and corresponding International (PCT) Publication No. WO 99/32158, the entire contents of which are hereby incorporated in the present specification by reference. The preferred antimicrobial agents are polyquaternium-1, MAPDA and the amino biguanide identified in WO 99/32158 as “Compound Number 1”.

The compositions of the present invention that are intended for use in treating contact lenses will contain one or more ophthalmically acceptable antimicrobial agents in an amount effective to prevent microbial contamination of the compositions (referred to herein as “an amount effective to preserve”), or in an amount effective to disinfect contact lenses by substantially reducing the number of viable microorganisms present on the lenses (referred to herein as “an amount effective to disinfect”).

The levels of antimicrobial activity required to preserve ophthalmic compositions from microbial contamination or to disinfect contact lenses are well known to those skilled in the art, based both on personal experience and official, published standards, such as those set forth in the United States Pharmacopoeia (“USP”) and similar publications in other countries.

The compositions of the present invention are preferably formulated as multi-purpose solutions for treating contact lenses, but may also be formulated as a separate cleaning product or as a product for rewetting contact lenses (e.g., rewetting drops), rather than as a multi-purpose solution.

The compositions and methods of the present invention are further illustrated by means of the examples presented below.

### EXAMPLE 1

### Representative Compositions of the Invention

The formulations shown in Tables 1 and 2 below are representative of the compositions of the present invention. All concentrations shown are expressed as weight/volume percent. The formulations were prepared in accordance with known procedures.

TABLE 1

| | Formulation Numbers/Concentrations (w/v %) | | | | |
|---|---|---|---|---|---|
| Component | 9198-17A | 9198-17B | 9198-17G | 8874-90H | 9198-17J |
| Polyqua- | 0.0011 | 0.0011 | 0.0011 | 0.0011 | 0.0011 |
| ternium-1 | | | | | |
| Sodium | — | 0.6 | — | 0.6 | — |
| Citrate | | | | | |
| Sorbitol | 1.5 | 1.5 | 1.5 | 1.5 | 1.5 |
| Boric Acid | 0.6 | 0.6 | 0.6 | 0.6 | 0.6 |
| Sodium | 0.32 | 0.32 | 0.32 | 0.32 | 0.32 |
| Chloride | | | | | |
| Carboxy- | 0.2 | 0.2 | 0.5 | — | — |
| methyl | | | | | |
| Chitosan | | | | | |
| PH | 7.0 | 7.0 | 7.0 | 7.5 | 7.0 |

Formulation numbers 9198-17J and 8874-90H did not contain a chitosan derivative, and therefore represent the vehicles for other formulations shown in Table 1.

TABLE 2

| | Formulation Numbers/Concentrations (w/v %) | | |
|---|---|---|---|
| Component | 9198-15F | 9198-09D | 9198-09H |
| Boric acid | 0.6 | 0.6 | 0.6 |
| Sorbitol | 1.5 | 1.5 | 1.5 |
| Sodium chloride | 0.32 | 0.32 | 0.32 |
| Carboxymethyl chitosan | 0.2 | 0.5 | — |
| pH | 7.5 | 7.5 | 7.5 |

Formulation Number 9198-09H does not contain a chitosan derivative, and therefore represents the vehicle for the compositions described above.

### EXAMPLE 2

### Methods and Procedures for Assessment of Cleaning Efficacy

The ability of the compositions described in Example 1 to remove protein deposits from contact lenses was evaluated by means of the procedures described below.

I. Lens Deposition Procedure

Acuvue™ lenses were selected for this evaluation. Each lens was immersed in a glass vial containing 5 ml lysozyme solution and incubated at 37° C. for 24 hours. After incubation, the deposited lenses were removed and rinsed by dipping into three consecutive beakers containing 50 ml deionized water to remove the excess lysozyme.

II. Cleaning Procedure

The soiled lenses were soaked and shaken with 5 ml each of the test solutions in a glass vial at room temperature for 16 hours. After the soaking/cleaning period, the lenses were removed from their respective test solutions and rinsed by dipping into three consecutive beakers containing 20 mL of Unisol®4 saline solution. Mechanical rubbing of the lenses was not included as part of the cleaning regimen. (This is referred to below as the “no rub” regimen.) The cleaned lenses were then subjected to the extraction procedure described below.

III. Extraction and Determination of Lysozyme

Both treated and non-treated (as a control) lenses were then extracted with 5 ml each of an extraction solution comprising of acetylnitrile/water/trifluoroacetic acid (500/500/1, v/v) in a glass vial. The extraction was conducted by shaking the vial with a rotary shaker at room temperature for at least 2 hours (usually overnight).

Quantitative determination of the lysozyme from the lens extract and lens soaking solution was carried out by a fluorescence spectrophotometer operated with an autosampler and computer. The fluorescence intensity of a 2 ml aliquot from each sample was measured by setting the excitation/emission wavelength at 280 nm/346 nm with excitation/emission slits of 2.5 nm/10 nm respectively, and the sensitivity of the photomultiplier was set at 950 volts.

A lysozyme standard curve was established by diluting the lysozyme stock solution to the concentrations ranging from 0 to 60 μg/ml with either the extraction solution or the individual test solution. The fluorescence measurement was carried out using the same instrumental settings as those used for the lens extracts and lens soaking solutions. The lysozyme concentration for all of the samples were calculated based on the slope developed from the linear lysozyme standard curve.

IV. Cleaning Efficacy

The cleaning efficacy of the test solutions was determined by calculating the percentage of protein removal. The calculation was based on a comparison of the amount of lysozyme extracted from soiled lenses that were not treated versus the amount extracted from lenses that were treated with the test solutions.

V. Results

The results of the above-described evaluation are provided in Tables 3 and 4, below.

TABLE 3
Cleaning Efficacy of Compositions Containing
Chitosan Derivatives
The results obtained with the solutions described
in Table 1 above were as follows:

| Composition | % Cleaning | STDV |
|---|---|---|
| 0.2% Carboxymethyl Chitosan; no citrate | 38.6 | 1.1 |
| (9198-17A) | | |
| 0.2% Carboxymethyl Chitosan with citrate | 39.7 | 0.7 |
| (9198-17B) | | |
| 0.5% Carboxymethyl Chitosan; no citrate | 42.0 | 0.2 |
| (9198-17G) | | |
| Vehicle with 0.6 w/v % sodium citrate; pH of 7.5 | 32.4 | 1.7 |
| (8874-90H) | | |
| Vehicle without citrate; pH 7.0 (9198-17J) | 8.0 | 0.2 |

TABLE 4
Cleaning Efficacy of Compositions Containing
Chitosan Derivatives.
The results obtained with the solutions described in
Table 2 above were as follows:

| Composition | % Cleaning | STDV |
|---|---|---|
| 0.5% Carboxymethyl Chitosan (9198-09D) | 42.2 | 0.4 |
| 0.2% Carboxymethyl Chitosan (9198-15F) | 39.1 | 0.6 |
| Vehicle (9198-09H) | 8.7 | 0.2 |

### EXAMPLE 3

### Assessment of Desiccation Protection

The desiccation protection capability of formulations containing chitosan derivatives was evaluated by a method using the viability dye, 3-[4,5-dimethylthiazol-2-yl]-2,5-diphenyltetrazolium bromide (MTT), with a human corneal epithelial cell culture (CEPI 17). MTT is a tetrazolium salt, which has been used to develop a quantitatively calorimetric assay for mammalian cell survival and proliferation. The assay detects living, but not dead cells. This method was utilized to assess the drying protection capability of compositions of the present invention by measuring the cell viability after exposure to the test solution, followed by drying in an airflow hood.

The assay was conducted in a cell culture plate containing 96 or 48 wells. When the cells reached the confluent stage, the medium was removed and the cells in each well were added with the test solution. After 10 minutes exposure at 37° C., the solution was removed and the cells were left inside an airflow hood to dry for 30 to 60 minutes. 100 or 200 μl of MTT solution was then added to each well and the plate was incubated at 37° C. for 4 hours. The MTT formazan blue crystals produced by the viable cells became visible after incubation. An aliquot of acidic isopropanol was added to dissolve the blue precipitate after carefully removing the solution from the well. A microplate reader at 570 nm was used to determine the intensity of the color solution. The wells with serum/medium and the wells with vehicle solution were also run in the same plate as a total viable and a dead control respectively. The results are presented in Tables 5 and 6 below:

TABLE 5
Desiccation Protection of Chitosan
Derivatives in Unisol 4 Vehicle

| Formulations | % Protection | STDV | mOsm | pH |
|---|---|---|---|---|
| 0.5% Carboxymethyl Chitosan | 81.6 | 5.7 | 303 | 7.30 |
| Unisol 4 (Vehicle) | 27.3 | 17.6 | 295 | 7.00 |
| Tears Naturale II ® | 83.2 | 12.4 | 292 | 7.00 |

TABLE 6
Desiccation Protection of Chitosan Derivatives
in Polyquaternium-1 Formulation

| | Desiccation | |
|---|---|---|
| Solutions | Protection (%) | SDTV |
| 0.2% Carboxymethyl Chitosan (9198-15F) | 87.7 | 31.0 |
| 0.5% Carboxymethyl Chitosan(919815-15D) | 84.6 | 33.8 |
| Tears Naturale II ® | 82.1 | 10.4 |
| Tears Naturale Forte ® | 84.1 | 12.1 |
| Vehicle | 23.0 | 2.3 |
| HBSS Control | 26.2 | 3.4 |

*Cells: CEPI 17, p97, a human corneal epithelial cell line.
*Assayed by MTT viability assay and 40 minutes desiccation.

I claim:

1. An aqueous composition for cleaning contact lenses, comprising an effective amount of an anionic chitosan derivative that is soluble in aqueous solutions at a pH of 6.5 to 8.5 and is capable of complexing with lysozyme as a result of ionic interactions, and an ophthalmically acceptable aqueous vehicle for said chitosan derivative.

2. A composition according to claim 1, wherein the chitosan derivative has a molecular weight of 500 to 10,000,000 Daltons.

3. A composition according to claim 1, wherein the chitosan derivative is selected from the group consisting of sulfuryl chitosan, phosphoryl chitosan, carboxymethyl chitosan, dicarboxymethyl chitosan, succinyl chitosan, and combinations thereof.

4. A composition according to claim 1, wherein the chitosan derivative comprises carboxymethyl chitosan.

5. A composition according to claim 1, wherein the composition is a multi-purpose solution for cleaning and disinfecting contact lenses.

6. A composition according to claim 1, wherein the composition is a product for rewetting contact lenses.

7. A method of treating a contact lens, which comprises applying a cleaning composition to the lens, said composition comprising an effective amount of an anionic chitosan derivative that is soluble in aqueous solutions at a pH of 6.5 to 8.5 and is capable of complexing with lysozyme as a result of ionic interactions, and an ophthalmically acceptable aqueous vehicle for said chitosan derivative.

8. A method according to claim 7, wherein the chitosan derivative has a molecular weight of 500 to 10,000,000 Daltons.

9. A method according to claim 7, wherein the chitosan derivative is selected from the group consisting of sulfuryl chitosan, phosphoryl chitosan, carboxymethyl chitosan, dicarboxymethyl chitosan, succinyl chitosan, and combinations thereof.

10. A method according to claim 7, wherein the chitosan derivative comprises carboxymethyl chitosan.

11. A method according to claim 7, wherein the composition is a multi-purpose solution for cleaning and disinfecting contact lenses.

12. A method according to claim 7, wherein the composition is a product for wetting contact lenses.
